(19) United States
(12) Patent Application Publication
(10) Pub. No.: US 2010/0310279 A1
(43) Pub. Date: Dec. 9, 2010

(54) IMAGE FORMING APPARATUS

(76) Inventor: Yoshihisa MIZUMOTO, Kobe-shi (JP)

Correspondence Address: BIRCH STEWART KOLASCH & BIRCH, PO BOX 747, FALLS CHURCH, VA, 22040-0747, US

(21) Appl. No.: 12/753,480

(22) Filed: Apr. 2, 2010

(30) Foreign Application Priority Data
Jun. 9, 2009 (JP) 2009-138432

(51) Int. Cl. G03G 15/08

(52) U.S. Cl. 399/279

(57) ABSTRACT

An image forming apparatus 1 of the present invention has a precession preventing member 8. The member 8 presses a photosensitive drum 2 in an opposite direction against a press-contact force of a developing roller 6. The member 8 is arranged in an area on the outer circumferential surface 10 of the photosensitive drum 2 opposite, with a center axis 3 sandwiched, to a position where the developing roller 6 is press-contacted.

### BACKGROUND OF THE INVENTION

The present invention relates to an image forming apparatus using so-called electrophotography.

In an image forming apparatus using electrophotography such as a laser printer, an electrostatic copier, a plain paper facsimile device and a complex machine thereof, a cylindrical photosensitive drum is rotated in one direction around a center axis and is exposed to light while an outer circumferential surface of the photosensitive drum is uniformly charged, an electrostatic latent image corresponding to an image to be formed is formed on the outer circumferential surface (a charging process to an exposing process), and after the electrostatic latent image is developed to a toner image by selectively attaching toner previously charged (developing process), the toner image is transferred to a surface of a sheet of paper (hereinafter including a plastic sheet or the like) (transferring process) and is further fixed (fixing process), whereby an image is formed on the surface of the sheet of paper. Further, after the toner image is transferred to the surface of the sheet of paper, residual toner is removed from the surface of the photosensitive drum in a cleaning process, and then the photosensitive drum is used for the next image formation.

In the developing process among all of the above processes, a developing roller which is press-contacted to the outer circumferential surface of the photosensitive drum in one direction may be used.

This developing roller may be a roller having a cylindrical roller body and a shaft which is fitted in a cylinder of the roller body to be integral with the roller body.

Further, the roller body is usually formed of, for example, a conductive or semi-conductive elastomer such as a conductive rubber composition in order that a predetermined developing voltage is applied between the roller body and the photosensitive drum to attach toner to an electrostatic latent image. Further, hardness of the roller body formed of an elastomer is usually adjusted so that a predetermined nip width (a circumferential contact length between the photosensitive drum and the roller body) is secured when the roller body is press-contacted to the outer circumferential surface of the photosensitive drum.

While the developing roller is rotated around the shaft with the roller body thereof press-contacted to the outer circumferential surface of the photosensitive drum in one direction, a predetermined developing voltage is applied between the developing roller and the photosensitive drum, whereby the toner which is previously charged to be retained on a surface of the roller body is selectively attached to an electrostatic latent image by using a potential difference to develop a toner image.

The photosensitive drum may be a photosensitive drum where a single photosensitive layer or a plurality of photosensitive layers having photoconductivity is formed on an outer circumferential surface of a cylindrical base member (drum) formed of a conductive material such as aluminum.

The above photosensitive drum retains a generally uniform charging characteristic and the like over an entire surface of an image forming region defined on the outer circumferential surface of the base member. Therefore, in order that opposite axial end portions of a center axis, where electric charge is more easily concentrated than the other areas of the outer circumferential surface at the time of charging or the like, does not overlap with the image forming region, an area with a predetermined width which is not used for image formation (non-image forming region) is usually defined on each of the opposite end portion.

Further, in the above photosensitive drum, a photosensitive layer is generally not formed on areas with a predetermined width of the opposite axial end portions of the outer circumferential surface where a stress is easily concentrated at the times of forming a photosensitive layer, using the photosensitive drum, and the like (that is, in particular, areas of the opposite end portions of the base member of the non-image forming region).

Therefore, an axial length of the developing roller is generally smaller than an axial length of the photosensitive drum, more specifically, larger than an axial width of the image forming region and smaller than an axial width of the photosensitive layer, in order to prevent the developing roller from contacting the base member exposed on the opposite end portions to cause a short circuit.

However, in a state where the developing roller whose axial length is smaller than that of the photosensitive drum is press-contacted to the outer circumferential surface of the photosensitive drum, a press-contact force of the developing roller increases toward the opposite axial end portions and decreases toward a center portion. Therefore, a load tends to concentrate on the opposite end portions of the developing roller.

Further, each of the above-mentioned portions should have a predetermined tolerance at the time of design so that working and assembly to form them and rotation thereof are performed smoothly. Therefore, the press-contact force of the developing roller also tends to become nonuniform on the opposite axial end portions because of the above-mentioned tolerance.

If the photosensitive drum is rotated while the press-contact force of the developing roller is nonuniform on each axial portion as mentioned above, the photosensitive drum may be in precessional rotation to cause poor image formation of a formed image or to reduce image quality.

That is, when the photosensitive drum is in precessional rotation, the developing roller, a charging roller which is press-contacted to the photosensitive drum in the charging process, a transferring roller which is press-contacted to the photosensitive drum in the transferring process with a sheet of paper sandwiched therebetween, a cleaning roller and a cleaning blade which are press-contacted to the photosensitive drum in the cleaning process, and the like are separated from the photosensitive drum, whereby various types of poor image formation of an formed image are caused, or image quality of the formed image is reduced because of variation of the press-contact force even when they are not separated.

The problems caused by the precessional rotation significantly occur in a so-called high-speed machine where the number of image formation per predetermined time is large, and therefore, where a rotating velocity of the photosensitive drum is high.

Patent Documents 1 and 2 describe that a cylinder of a photosensitive drum contains a weight so that a vibration frequency of the photosensitive drum is varied to suppress vibration at the time of rotation. Further, Patent Document 3 describes that vibration at the time of rotation is suppressed by incorporating a flywheel into a rotation mechanism of a photosensitive drum.

However, in any of the above structures, a weight is increased by containing the weight or by incorporating the flywheel, thereby to increase power consumption required to rotate the photosensitive drum. Therefore, they cannot satisfy a requirement for energy-saving of an image forming apparatus which contributes to prevention of the global warming in recent years. Further, in the latter case, the rotation mechanism of the photosensitive drum becomes complicated or an extra space is needed because of incorporating the flywheel. Therefore, it cannot satisfy requirements for simplification, size reduction and no maintenance of an image forming apparatus which have increased recently.

Patent Documents 4 and 5 describe that a roller body of a developing roller is formed of a material softer than usual, and at the same time, that an outer circumferential surface of the developing roller is covered with a coating harder than the roller body to suppress abrasion.

In this structure, the nip width described above can be larger. Therefore, poor image formation caused by separation of the developing roller because of precessional rotation of a photosensitive drum can be suppressed. However, since it cannot prevent the precessional rotation itself, poor image formation caused by separation of other rollers or the like from the photosensitive drum, reduction of image quality caused by variation of the press-contact force, and the like cannot be suppressed.

### [Prior Art Documents]

### [Prior Art Document 1] Japanese Unexamined Patent Publication No. 05-188839

### [Prior Art Document 2] Japanese Unexamined Patent Publication No. 2002-116661

### [Prior Art Document 3] Japanese Unexamined Patent Publication No. 08-202205

### [Prior Art Document 4] Japanese Unexamined Patent Publication No. 2007-313883

### [Prior Art Document 5] Japanese Unexamined Patent Publication No. 2007-286236

### SUMMARY OF THE INVENTION

The present invention aims at providing an image forming apparatus which can reliably prevent precessional rotation of a photosensitive drum by a structure as simple as possible and as having a small space as possible without increasing power consumption and the like required for rotating the photosensitive drum, and as a result, which prevents poor image formation and image quality reduction caused by the precessional rotation.

The present invention provides an image forming apparatus, comprising a cylindrical photosensitive drum, and a developing roller press-contacted to an outer circumferential surface of the photosensitive drum in one direction, wherein the photosensitive drum is charged and exposed to light while being rotated in one direction around a center axis thereof, whereby an electrostatic latent image is formed on the outer circumferential surface, the developing roller selectively attaches charged toner to the electrostatic latent image while being rotated in a state of being press-contacted to the outer circumferential surface in one direction, whereby the electrostatic latent image is developed to a toner image to form an image, and a precession preventing member which presses the photosensitive drum in an opposite direction against a press-contact force of the developing roller is arranged in an area opposite, with the center axis sandwiched, to a position on the outer circumferential surface of the photosensitive drum where the developing roller is press-contacted.

According to the present invention, precessional rotation of the developing roller at the time of rotation can be suppressed by pressing the photosensitive drum with the precession preventing member in the opposite direction against the press-contact force of the developing roller. That is, the precessional rotation at the time of rotation can be suppressed by pressing the photosensitive drum with the developing roller and the precession preventing member in two directions which sandwich the center axis of the photosensitive drum.

Therefore, it can be suppressed that each member such as the developing roller which is press-contacted to the outer circumferential surface of the photosensitive drum is separated from the outer circumferential surface to cause poor image formation and that the press-contact force of each member varies to reduce image quality.

Moreover, the precession preventing member which is integrally formed of an elastomer and the like, has a simple structure and requires a smaller space can be used. Therefore, the precession preventing member does not complicate a structure of an image forming apparatus, and does not prevent downsizing of an image forming apparatus. Further, since there is not a need to incorporate a weight into the photosensitive drum or to incorporate a flywheel into the rotation mechanism, power consumption and the like required for rotating the photosensitive drum do not increase.

Preferably, the precession preventing member is arranged at a predetermined position within an area between a position which is rotated by 45° in a rotating direction of the photosensitive drum from a position opposite, with the center axis sandwiched, to a position on the outer circumferential surface of the photosensitive drum where the developing roller is press-contacted and a position which is rotated by 45° in a direction opposite to the rotating direction.

According to this, the photosensitive drum can be more effectively pressed by the precession preventing member, so that the precessional rotation of the photosensitive drum can be more effectively suppressed.

Preferably, a plurality of the precession preventing members are arranged at intervals with each other in an axial direction of the center axis of the photosensitive drum.

According to this, a contact area between the photosensitive drum and the precession preventing member can be made as small as possible. Therefore, it can be prevented that friction therebetween increases power consumption and the like required for rotating the photosensitive drum, and it can be also prevented that the surface of the photosensitive drum is damaged or worn out by the friction.

Preferably, the developing roller includes a roller body formed of an elastomer, and the precession preventing member is formed of a material softer than the elastomer forming the roller body.

According to this, it can be prevented that friction between the photosensitive drum and the precession preventing member increases power consumption and the like required for rotating the photosensitive drum, and it can be also prevented that the surface of the photosensitive drum is damaged or worn out by the friction.

The present invention can provide an image forming apparatus which can reliably prevent precessional rotation of a photosensitive drum by a structure as simple as possible and as having a small space as possible without increasing power consumption and the like required for rotating the photosensitive drum, and as a result, which prevents poor image formation and image quality reduction caused by the precessional rotation.

### BRIEF DESCRIPTION OF THE DRAWINGS

FIG. 1 is a schematic view showing a structure around a photosensitive drum which is a major portion of an embodiment of an image forming apparatus of the present invention.

FIG. 2 is a perspective view showing an example of a precession preventing member used for the image forming apparatus in FIG. 1.

FIG. 3 is a front view showing a state where the precession preventing members in FIG. 2 are arranged on an outer circumferential surface of the photosensitive drum.

FIG. 4 is a perspective view showing another example of a precession preventing member used for the image forming apparatus in FIG. 1.

FIG. 5 is a perspective view showing yet another example of a precession preventing member used for the image forming apparatus in FIG. 1.

FIG. 6 is a front view showing a state where yet another example of a precession preventing member used for the image forming apparatus in FIG. 1 is arranged on the outer circumferential surface of the photosensitive drum.

FIG. 7 is a front view showing a schematic structure of a test machine which was used for examining effects of the precession preventing members in Examples of the present invention and Comparative Examples.

FIG. 8 is a side view of the test machine in FIG. 7.

### DETAILED DESCRIPTION OF THE INVENTION

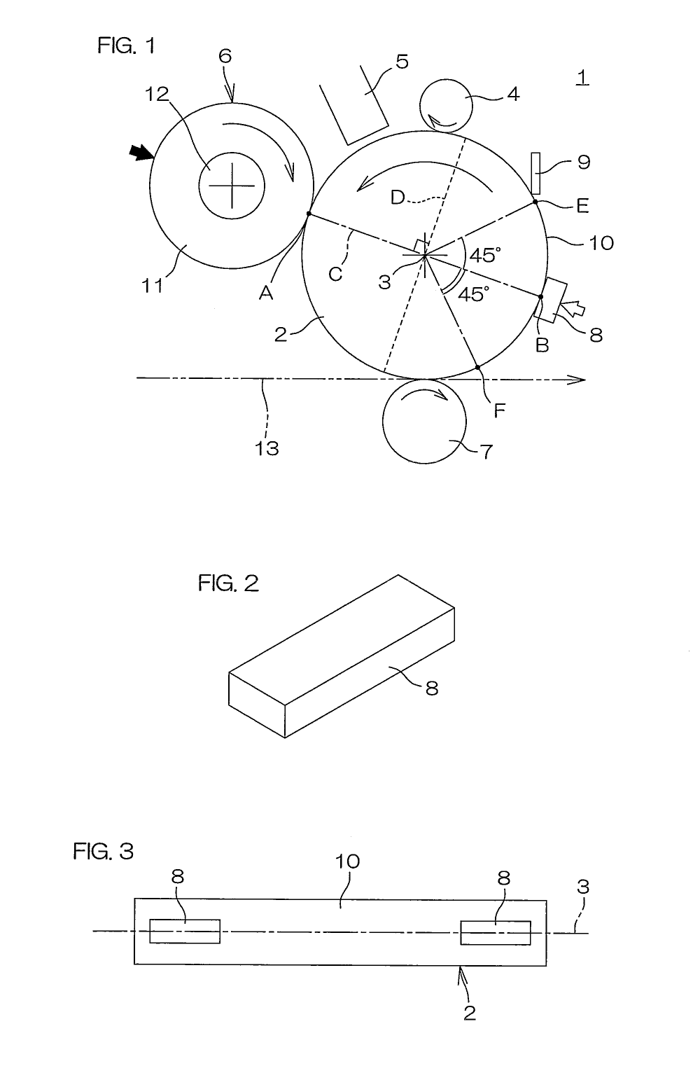

FIG. 1 is a schematic view showing a structure around a photosensitive drum which is a major portion of an embodiment of an image forming apparatus of the present invention.

Referring to FIG. 1, the image forming apparatus 1 in this example includes a cylindrical photosensitive drum 2. The photosensitive drum 2 may be, for example, the above-described photosensitive drum where a single photosensitive layer or a plurality of photosensitive layers having a photoconductivity is formed on an outer circumferential surface of a cylindrical base member (drum) formed of a conductive material such as aluminum, even though this is not shown. The photosensitive drum 2 is rotated around a center axis 3 in a direction shown by a solid arrow in the figure.

A charging roller 4, an exposing unit 5, a developing roller 6, a transferring roller 7, a precession preventing member 8 and a cleaning blade 9 are arranged around the photosensitive drum 2 in this order.

The charging roller 4 is formed of a conductive rubber composition or the like, for example. The charging roller 4 is rotated in a direction shown by a solid arrow in the figure while press-contacted to the outer circumferential surface 10 of the photosensitive drum 2. At this time, the charging roller 4 uniformly charges the outer circumferential surface 10 by applying a predetermined charging voltage between the charging roller 4 and the photosensitive drum 2 (charging process).

In a digital-type image forming apparatus, for example, a laser array, where a plurality of semiconductor lasers are arranged in an axial direction of the center axis of the photosensitive drum 2, or the like is used as the exposing unit 5. The exposing unit 5 exposes to light the outer circumferential surface 10 of the photosensitive drum 2 which is uniformly charged in the preceding charging process to form on the outer circumferential surface 10 an electrostatic latent image corresponding to an image to be formed (exposing process).

The developing roller 6 includes a cylindrical roller body 11 formed of a conductive rubber composition or the like, and a shaft 12 fitted into a cylinder of the roller body 11 to be integral with the roller body 11.

While the developing roller 6 is rotated in a direction shown by a solid arrow in the figure with the roller body 11 press-contacted to the outer circumferential surface 10 of the photosensitive drum 2 as shown by a black arrow in the figure, a predetermined developing voltage is applied between the developing roller 6 and the photosensitive drum 2, whereby toner which is previously charged and retained on a surface of the roller body 11 is selectively attached to the electrostatic latent image by using a potential difference to develop a toner image (developing process).

The transferring roller 7 is formed of a conductive rubber composition, for example. The transferring roller 7 is rotated in a direction shown by a solid arrow in the figure while it is press-contacted to the outer circumferential surface 10 of the photosensitive drum 2 with a sheet of paper 13 sandwiched therebetween. At this time, the transferring roller 7 serves to transfer the toner image to a surface of the sheet of paper 13 by applying a predetermined transferring voltage between the transferring roller 7 and the photosensitive drum 2 (transferring process).

The cleaning blade 9 is formed of a rubber composition, for example. The cleaning blade 9 is press-contacted to the outer circumferential surface 10 of the photosensitive drum 2, and serves to remove residual toner on the outer circumferential surface 10 after the toner image is transferred to a surface of the sheet of paper 13 (cleaning process).

The photosensitive drum 2 undergoes the above respective processes during one rotation around the center axis in the direction shown by the solid arrow in the figure, thereby to form a toner image (printed image) on the surface of the sheet of paper 13. The sheet of paper 13 on the surface of which the toner image is transferred in the transferring process is sent to a fixing process not shown, and is output after the toner image is fixed (heated, pressured or the like) in the fixing process.

The precession preventing member 8 is formed of an elastomer such as a rubber. In the case of this figure, the precession preventing member 8 is arranged in a position B on the outer circumferential surface 10 of the photosensitive drum 2 which is, with the center axis 3 sandwiched, opposite to a position A where the developing roller 6 is press-contacted. The precession preventing member 8 is press-contacted to the outer circumferential surface 10 at the position B, and presses the photosensitive drum 2 in an opposite direction against a press-contact force of the developing roller 6 (shown by the black arrow), as shown by a hollow arrow in the figure.

Accordingly, precessional rotation of the photosensitive drum 2 at the time of rotation can be suppressed by pressing the photosensitive drum 2 with the developing roller 6 and the precession preventing member 8 in the two directions sandwiching the center axis 3. Therefore, it can be suppressed that each member such as the developing roller 6 which is press-contacted to the outer circumferential surface 10 of the photosensitive drum 2 is separated from the outer circumferential surface 10 to cause poor image formation and that the press-contact force of each member varies to reduce image quality.

Moreover, the precession preventing member 8 which has a simple structure as in the figure and requires a smaller space can be used. Therefore, the precession preventing member 8 does not complicate a structure of the image forming apparatus 1, and does not prevent downsizing of the image forming apparatus 1. Further, since there is not a need to incorporate a weight into the photosensitive drum or to incorporate a flywheel into the rotation mechanism, power consumption and the like required for rotating the photosensitive drum 2 do not increase.

The precession preventing member 8 can be arranged on any position within an area on the outer circumferential surface 10 of the photosensitive drum 2 opposite, with the center axis 3 sandwiched, to the position where the developing roller 6 is press-contacted, that is, within an area in the figure rightward of a straight line D shown by a dashed line in the figure which is orthogonal to a straight line C connecting the above-mentioned positions A and B and passing the center axis 3.

The precession preventing member 8 can be arranged on any position within the above area according to a relation to the other members arranged around the photosensitive drum 2.

That is, the precession preventing member 8 can be arranged on any position within the above area which is forward of the transferring roller 7 in a rotating direction of the photosensitive drum 2 and rearward of the charging roller 4 in this rotating direction (a position where image formation in the above respective processes is not hindered).

However, considering that the precessional rotation of the photosensitive drum 2 is more efficiently suppressed by pressing the photosensitive drum 2 with the precession preventing member 8 more effectively, the precession preventing member 8 is preferably arranged in the area between a position E, which is rotated by 45° in the rotating direction of the photosensitive drum 2 from the position B on the outer circumferential surface 10, and a position F which is rotated by 45° in an opposite direction to the rotating direction, and is particularly preferably arranged in the position B.

Further, the precession preventing member 8 may be arranged in a position in view of, for example, not only the press-contact force of the developing roller 6 but also press-contact forces of the charging roller 4, the transferring roller 7, and moreover, the cleaning blade 9.

As described above, the precession preventing member 8 is formed of an elastomer.

FIG. 2 is a perspective view showing an example of a precession preventing member 8 used for the image forming apparatus 1 in FIG. 1. FIG. 3 is a front view showing a state where the precession preventing members 8 in FIG. 2 are arranged on the outer circumferential surface 10 of the photosensitive drum 2.

Referring to FIG. 2, the precession preventing member 8 in this example has a rectangular parallelepiped shape.

Further, referring to FIG. 3, a plurality of the precession preventing members 8 (two in the figure) are arranged in the axial direction of the center axis 3 of the photosensitive drum 2 at an interval with each other.

According to this, a contact area between the photosensitive drum 2 and the precession preventing members 8 can be made as small as possible. Therefore, it can be prevented that friction therebetween increases power consumption and the like required for rotating the photosensitive drum 2, and it can be also prevented that the photosensitive layer on the surface of the photosensitive drum 2 is damaged or worn out by the friction. In view of reducing an influence of the above damage and wear-out, it is particularly preferable that the precession preventing members 8 is brought into contact to the non-image forming region on the outer circumferential surface 10 of the photosensitive drum 2.

The precession preventing members 8 is preferably formed of a material softer than the elastomer such as a conductive rubber composition forming the roller body 11 of the developing roller 6.

According to this, it can be prevented that friction between the photosensitive drum 2 and the precession preventing member 8 increases power consumption and the like required for rotating the photosensitive drum 2, and it can be also prevented that the photosensitive layer on the surface of the photosensitive drum 2 is damaged or worn out by the friction. The softer material forming the precession preventing member 8 is preferably an elastomer such as a rubber, a porous body formed of a soft resin or the like.

The description that the material forming the precession preventing member 8 is “softer” than the elastomer forming the roller body 11 of the developing roller 6 means the following: When comparing hardness which is measured according to the measuring method defined by various standards such as Japanese Industrial Standards JIS K6253:2006 “Rubber, vulcanized or thermoplastic—Determination of hardness” and JIS K6301:1995 “Physical testing methods of vulcanized rubber,” the material forming the precession preventing member 8 is within a range where its hardness is smaller than that of the elastomer forming the roller body 11 of the developing roller 6.

In view of securing a predetermined nip width when the roller body is pressed to the outer circumferential surface 10 of the photosensitive drum 2 as described above, the hardness of the roller body 11 of the developing roller 6 is preferably not less than 60 Hs and not more than 80 Hs shown by the spring type A hardness defined in above JIS K6301:1995. Further, in view of excellently obtaining the above effect, the hardness of the precession preventing member 8 formed of a porous body which is used in combination with the roller body 11 is preferably not more than E50 and is particularly preferably not less than E30 Hs and not more than E45 shown by the durometer type E hardness defined in above JIS K6253:2006.

The precession preventing member 8 may directly attached by an adhesive or the like to a position, where it is opposed to the outer circumferential surface 10 of the photosensitive drum 2 and is in the above-described positional relation to the developing roller 6, on a casing of the image forming apparatus, a casing of a toner cartridge removably mounted in the casing of the image forming apparatus, or the like in a manner that the precession preventing member 8 is adjacent to the outer circumferential surface 10.

However, it is preferable that the precession preventing member 8 is attached to the above position via a spring or the like and is brought into contact to the outer circumferential surface 10 by a pressing force of the spring or the like. According to this, the effect of preventing that friction between the photosensitive drum 2 and the precession preventing member 8 increases power consumption and the like required for rotating the photosensitive drum 2 can be further improved, and also the effect of preventing that the photosensitive layer on the surface of the photosensitive drum 2 is damaged or worn out by the friction can be further improved.

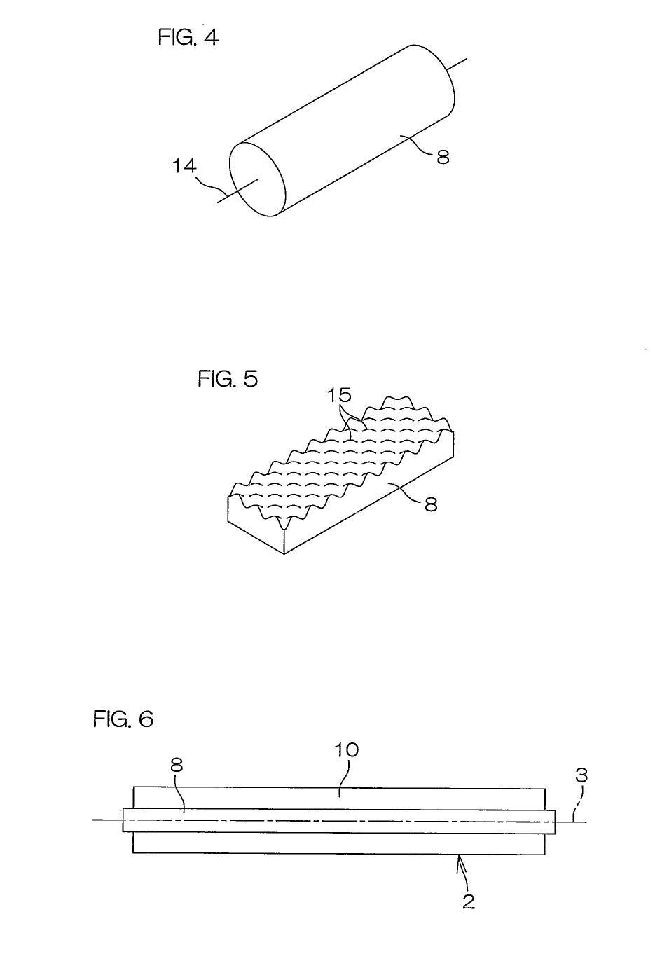

FIG. 4 is a perspective view showing another example of a precession preventing member 8 used for the embodiment of the image forming apparatus 1 in FIG. 1.

Referring to FIG. 4, the precession preventing member 8 in this example is formed of the above-mentioned porous body or the like in a columnar shape. The precession preventing member 8 is press-contacted to the outer circumferential surface 10 of the photosensitive drum 2 in a state where the precession preventing member 8 is rotatably supported around its center axis 14 with the center axis 14 directed in a direction parallel to the center axis 3 of the photosensitive drum 2.

According to this, the effect of preventing that friction between the photosensitive drum 2 and the precession preventing member 8 increases power consumption and the like required for rotating the photosensitive drum 2 can be further improved, and also the effect of preventing that the photosensitive layer on the surface of the photosensitive drum 2 is damaged or worn out by the friction can be further improved.

FIG. 5 is a perspective view showing yet another example of a precession preventing member used for the embodiment of the image forming apparatus in FIG. 1.

Referring to FIG. 5, the precession preventing member 8 in this example has a rectangular parallelepiped shape and includes a plurality of projections 15 on a surface press-contacted to the outer circumferential surface 10 of the photosensitive drum 2.

According to this, a contact area between the photosensitive drum 2 and the precession preventing members 8 can be made as small as possible. As a result, the effect of preventing that friction therebetween increases power consumption and the like required for rotating the photosensitive drum 2 can be further improved, and also the effect of preventing that the photosensitive layer on the surface of the photosensitive drum 2 is damaged or worn out by the friction can be further improved.

FIG. 6 is a front view showing a state where yet another example of a precession preventing member 8 used for the image forming apparatus 1 in FIG. 1 is arranged on the outer circumferential surface 10 of the photosensitive drum 2.

Referring to FIG. 6, the precession preventing member 8 may be formed in a single, continuous bar shape. According to this, the image forming apparatus 1 can be simplified by reducing the number of components.

The structure of the present invention is not limited to the above-mentioned examples shown in the figures. For example, the image forming apparatus 1 may include a charging unit and a transferring unit which use non-contact corona discharge in place of the charging roller 4 and the transferring roller 7. Further, it may include a cleaning roller in place of the cleaning blade 9. Any other alterations can be made as long as they do not change the outline of the present invention.

### EXAMPLES

### Example 1

### Developing Roller

An epichlorohydrin rubber [Epichlomer (trademark) manufactured by Daiso Co., Ltd] and a chloroprene rubber [manufactured by Showa Denko K.K.] were used as rubber components.

The above epichlorohydrin rubber was an ethylene oxide-epichlorohydrin binary copolymerized polymer, and its content ratio of an epichlorohydrin unit was 39 moll % and its content ratio of an ethylene oxide unit was 61 moll %.

Zinc oxide [two types of zinc oxide manufactured by Mitsui Mining & Smelting Co., Ltd.] and carbon black [Asahi#15 manufactured by Asahi Carbon Co., Ltd.; a mean primary particle diameter: 122 nm; light electric] were used as fillers.

Powdered sulfur [manufactured by tsurumi chemical] and ethylene thiourea [accel (trademark) 22-S manufactured by Kawaguchi Chemical Industry Co., LTD.] were used as vulcanizers.

Further, hydrotalcite [DHT-4A (trademark)-2 manufactured by Kyowa Chemical Industry Co., Ltd.] was used as an acid acceptor.

Mixed proportions of the above respective components were as shown in Table 1.

TABLE 1

| Components | Parts by mass |
|---|---|
| Epichlorohydrin rubber | 60 |
| Chloroprene rubber | 40 |
| Zinc oxide | 5 |
| Carbon black | 40 |
| Powdered sulfur | 0.5 |
| Ethylene thiourea | 1.4 |
| Hydrotalcite | 5 |

The rubber components from the above respective components were put in a kneader and mixed and kneaded at 110° C., and the carbon black and the zinc oxide were put in this order and further mixed and kneaded. Then, the vulcanizers and the acid acceptor were added to the obtained mixture and mixed and kneaded by a roll for 5 minutes to obtain a ribbon-shaped conductive rubber component.

Then, the conductive rubber component was extruded into a cylinder shape having an inner diameter of φ7.0 mm and an outer diameter of φ21 mm at a tube temperature of 50° C. using a vacuum-type extruder of φ60. Moisture other than those adsorbed in rubber molecules and air bubbles could be removed during this process.

Then, a metal shaft having an outer diameter of φ10 mm was press-fitted into the above cylinder under a pressurized environment, and was heated at 160° C. for 60 minutes in a vulcanizer to cross-link the rubber components.

Then, opposite ends were cut, and an outer circumferential surface was polished traverse using a cylinder polisher, and was further mirror-polished so that an outer diameter was φ20 mm (a tolerance: 0.05 mm) and a surface roughness of the outer circumferential surface was 3 to 5 μm shown by a maximum height roughness Rz of a curved outline defined in JIS B0601:2001 “Geometrical Product Specifications (GPS)—Surface texture: Profile method—Terms, definitions and surface texture parameters.” In this manner, a roller body integral with the above shaft was formed. An axial length of the shaft of the roller body was 235 mm.

Then, the outer circumferential surface of the roller body was washed with water, and thereafter, was irradiated with ultraviolet rays to form an oxide film on the outer circumferential surface, whereby a developing roller was produced. Specifically, by using an ultraviolet ray irradiator [PL21-200 manufactured by Sen Lights Co., Ltd.] and setting a distance between the outer circumferential surface of the roller body and an ultraviolet ray lamp to 10 cm, an operation that a circumferentially quarter area of the outer circumferential surface was irradiated by ultraviolet rays (wavelengths were 184.9 nm and 253.7 nm) for 300 seconds was performed 4 times while the roller body was rotated by 90° at a time, thereby to form an oxide film over an entire surface of the outer circumferential surface.

A spring type A hardness defined in JIS K6301:1995 of the roller body was 67 Hs.

### <Precession Preventing Member>

There was used a precession preventing member formed of a porous body in which an acrylonitrile butadiene rubber and the same epichlorohydrin rubber used for the above roller body of the developing roller were mixed at a mass ratio of 1:1 and chemically foamed, the precession preventing member being in a rectangular parallelepiped shape having a height of 5 mm, a width of 5 mm and a length of 20 mm.

A durometer type E hardness (at a load of 1000 g) defined in JIS K6253:2006 of the precession preventing member was E40.

### <Precession Preventing Test>

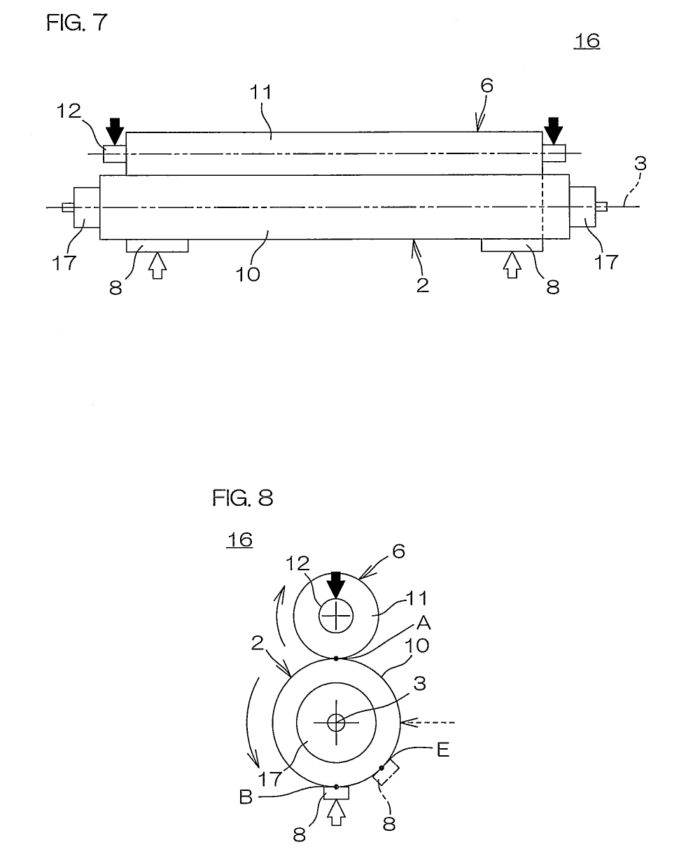

FIG. 7 is a front view showing a schematic structure of a test machine 16 used for examining effects of the precession preventing members 8. FIG. 8 is a side view of the test machine 16 in FIG. 7.

Referring to both the figures, a photosensitive drum 2 having an outer diameter of φ30 mm and an axial length of 260 mm removed from a commercial laser printer was rotatably supported by a pair of shaft supporting sockets 17, 17 for the photosensitive drum 2 removed from the commercial laser printer so that a center axis 3 of the photosensitive drum 2 was horizontal. In this state, the roller body 11 of the developing roller 6 previously produced was brought into contact to a position A on an outer circumferential surface 10 of the photosensitive drum 2 from a vertically upper side. The roller body 11 was brought into contact to the outer circumferential surface 10 while an axially center position of the roller body 11 was coincide with an axially center position of the photosensitive drum 2.

Opposite end portions of the shaft 12 projecting from opposite ends of the roller body 11 were respectively imposed with loads of 1 kg in a vertically lower direction as respectively shown by black arrows in the figures, whereby the roller body 11 was press-contacted to the outer circumferential surface 10 of the photosensitive drum 2.

Further, the two precession preventing members 8 arranged at an interval from each other were brought into contact to a position B on the outer circumferential surface 10 from a vertically lower side, and were press-contacted by respectively imposing loads of 500 g with springs not shown in a vertically upper direction as shown by hollow arrows in the figures. The precession preventing members 8 were respectively arranged such that end faces on opposite end portions of the photosensitive drum 2 were coincide with the opposite ends of the roller body 11 of the developing roller 6.

According to this, a model of the image forming apparatus 1 shown in FIG. 1 was structured. That is, the roller body 11 of the developing roller 6 was press-contacted to the position A on the outer circumferential surface 10 of the photosensitive drum 2 in one direction, and at the same time, the precession preventing member 8 was press-contacted to the opposite position B on the outer circumferential surface 10 with the center axis 3 sandwiched by a press-contact force in a direction opposite to a press-contacting direction of the roller body 11.

Then, the photosensitive drum 2 and the developing roller 6 were rotated by a driving mechanism not shown in directions which were reverse to each other as shown by solid arrows in FIG. 8. During this rotation, a displacement caused by a single rotation of the outer circumferential surface 10 of the photosensitive drum 2 was measured at an interval of 0.1 second using an electric micrometer at a position shown by a chain line in the figure which was rotated by 90° in a rotating direction of the photosensitive drum from a position where the precession preventing member 8 was press-contacted, and also which corresponded to one end of the roller body 11 of the developing roller 6 as shown by a chain line in FIG. 7. The number of rotation of the photosensitive drum 2 was set to 10 rpm.

When a difference between the maximum value and the minimum value of measured values was calculated as a precession amount of precessional rotation of the photosensitive drum 2, the precession amount was 50 μm.

Further, the above photosensitive drum 2, shaft supporting sockets 17, developing roller 6 and precession preventing member 8 were reincorporated into the laser printer while maintaining a positional relation in the figures. Then, an image was formed while a load of 1 kg was imposed on one end portion of the shaft 12 of the developing roller 6 and a load of 0.8 kg was imposed on the other end portion so that the loads were intentionally unbalanced at the end portions. When the formed image was checked, a difference of image quality was not found between end portions and a center portion of the formed image. Therefore, it was confirmed that an excellent image quality could be maintained in an entire surface of the formed image.

### Example 2

There was prepared a precession preventing member formed of a porous body in which an acrylonitrile butadiene rubber and the same epichlorohydrin rubber used for the above roller body of the developing roller were mixed at a mass ratio of 1:1 and chemically foamed, being in a column shape having an outer diameter of φ5 mm and a length of 235 mm, and having a durometer type E hardness (at a load of 1000 g) of E35.

Then, a model of the image forming apparatus was structured in a manner similar to Example 1 except that a center axis of the above precession preventing member was arranged in a direction parallel to the center axis of the photosensitive drum, and at the same time, that the precession preventing member was brought into contact to the outer circumferential surface of the photosensitive drum while the precession preventing member was rotatably supported around the center axis.

The precession preventing member was arranged so that opposite ends thereof were coincide with the opposite ends of the roller body of the developing roller, and was press-contacted to the outer circumferential surface of the photosensitive drum by imposing a load of 500 g.

A precession amount measured under the same conditions as in Example 1 was 30 μm. Further, the above respective components were reincorporated into the laser printer, and an image was formed under the same conditions as in Example 1. When the formed image was checked, a difference of image quality was not found between end portions and a center portion of the formed image. Therefore, it was confirmed that an excellent image quality could be maintained in an entire surface of the formed image.

### Example 3

There was prepared a precession preventing member formed of the same porous body used in Example 1 having a durometer type E hardness (at a load of 1000 g) of E40, the precession preventing member being in a rod shape having a height of 5 mm, a width of 5 mm and a length of 235 mm.

Then, a model of the image forming apparatus was structured in a manner similar to Example 1 except that the above precession preventing member was brought into contact to the outer circumferential surface of the photosensitive drum while a length direction of the precession preventing member was arranged in a direction parallel to a center axis of the photosensitive drum.

The precession preventing member was arranged so that opposite ends thereof were coincide with the opposite ends of the roller body of the developing roller, and was press-contacted to the outer circumferential surface of the photosensitive drum by imposing a load of 500 g.

A precession amount measured under the same conditions as in Example 1 was 50 μm. Further, the above respective components were reincorporated into the laser printer, and an image was formed under the same conditions as in Example 1. When the formed image was checked, a difference of image quality was rarely found between end portions and a center portion of the formed image even though the result was not so excellent as in Examples 1 and 2. Therefore, it was confirmed that an excellent image quality could be maintained in an entire surface of the formed image.

### Example 4

There was prepared a precession preventing member formed of a porous body in which an acrylonitrile butadiene rubber and the same epichlorohydrin rubber used for the above roller body of the developing roller were mixed at a mass ratio of 1:1 and chemically foamed, being in a rod shape having a height of 5 mm, width of 5 mm and length of 235 mm, and having a durometer type E hardness (at a load of 1000 g) of E30.

Then, a model of the image forming apparatus 1 was structured in a manner similar to Example 1 except that the above precession preventing member 8 was brought into contact to a position (the position E in FIG. 1) on the outer circumferential surface 10 of the photosensitive drum 2 which was rotated by 45° from the position B in the rotating direction of the photosensitive drum 2 as shown by an alternate long and short dash line in FIG. 8 while a length direction of the precession preventing member 8 was arranged in a direction parallel to the center axis 3 of the photosensitive drum 2.

The precession preventing member 8 was arranged so that opposite ends thereof were coincide with the opposite ends of the roller body 11 of the developing roller 6, and was press-contacted to the outer circumferential surface 10 of the photosensitive drum 2 by imposing a load of 500 g.

A precession amount measured under the same conditions as in Example 1 was 50 μm. Further, the above respective components were reincorporated into the laser printer, and an image was formed under the same conditions as in Example 1. When the formed image was checked, a difference of image quality was rarely found between end portions and a center portion of the formed image even though the result was not so excellent as in Examples 1 and 2. Therefore, it was confirmed that an excellent image quality could be maintained in the entire surface of the formed image.

### Comparative Example

A model of the image forming apparatus 1 was structured in a manner similar to Example 1 except that a precession preventing member was not brought into contact to the outer circumferential surface 10 of the photosensitive drum 2.

A precession amount measured under the same conditions as in Example 1 was 200 μm. Further, the above respective components were reincorporated into the laser printer, and an image was formed under the same conditions as in Example 1. When the formed image was checked, reduction of image quality was significant particularly on end portions of the formed image. Therefore, it was confirmed that an excellent image quality could not be maintained in an entire surface of the formed image.

The results described above are summarized in Table 2.

TABLE 2

| | Precession amount | Quality of |
|---|---|---|
| | (μm) | formed image |
| Example 1 | 50 | Very good |
| Example 2 | 30 | Very good |
| Example 3 | 50 | Good |
| Example 4 | 50 | Good |
| Comparative | 200 | Bad |
| Example | | |

What is claimed is:

1. An image forming apparatus, comprising a cylindrical photosensitive drum, and a developing roller press-contacted to an outer circumferential surface of the photosensitive drum in one direction; wherein
the photosensitive drum is charged and exposed to light while being rotated in one direction around a center axis thereof, whereby an electrostatic latent image is formed on the outer circumferential surface;
the developing roller selectively attaches charged toner to the electrostatic latent image while being rotated in a state of being press-contacted to the outer circumferential surface in one direction, whereby the electrostatic latent image is developed to a toner image to form an image; and
a precession preventing member which presses the photosensitive drum in an opposite direction against a press-contact force of the developing roller is arranged in an area opposite, with the center axis sandwiched, to a position on the outer circumferential surface of the photosensitive drum where the developing roller is press-contacted.

2. An image forming apparatus according to claim 1, wherein the precession preventing member is arranged at a predetermined position within an area between a position which is rotated by 45° in a rotating direction of the photosensitive drum from a position opposite, with the center axis sandwiched, to a position on the outer circumferential surface of the photosensitive drum where the developing roller is press-contacted and a position which is rotated by 45° in a direction opposite to the rotating direction.

3. An image forming apparatus according to claim 2, wherein a plurality of the precession preventing members are arranged at intervals with each other in an axial direction of the center axis of the photosensitive drum.

4. An image forming apparatus according to claim 3, wherein the developing roller includes a roller body formed of an elastomer; and
the precession preventing member is formed of a material softer than the elastomer forming the roller body.

5. An image forming apparatus according to claim 1, wherein a plurality of the precession preventing members are arranged at intervals with each other in an axial direction of the center axis of the photosensitive drum.

6. An image forming apparatus according to claim 1, wherein the developing roller includes a roller body formed of an elastomer; and
the precession preventing member is formed of a material softer than the elastomer forming the roller body.

7. An image forming apparatus according to claim 2, wherein the developing roller includes a roller body formed of an elastomer; and
the precession preventing member is formed of a material softer than the elastomer forming the roller body.
